(19) United States
(12) Patent Application Publication
(10) Pub. No.: US 2005/0025451 A1
(43) Pub. Date: Feb. 3, 2005

(54) Topic-oriented method of recording digital contents broadcast in accordance with a schedule

(75) Inventors: Christian Bertin, Rennes (FR); Sebastien Campion, Rennes (FR); Isabelle Amonou, Thorigne Fouillard (FR)

Correspondence Address: James R. Williams;Jameson, Seltzer, Harper & Williams, 2625 Wilmington Road, New Castle, PA, 16105, US

(73) Assignee: France Telecom, Paris (FR)

(21) Appl. No.: 10/765,448

(22) Filed: Jan. 27, 2004

(30) Foreign Application Priority Data
Jan. 27, 2003 (FR) 0300882

(51) Int. Cl. H04N 5/781

(52) U.S. Cl. 386/46; 386/125

(57) ABSTRACT

The method of recording audiovisual contents broadcast according to a schedule includes: a step of selecting from an access terminal an audiovisual content to be recorded associated with a broadcast date and time, and a step of the access terminal receiving a record file of the selected audiovisual content, said file containing information identifying the audiovisual content and the scheduled date and time for broadcasting it. It further comprises: a preliminary step of the access terminal selecting a set of contents having a common topic, said set being offered by an audiovisual content presentation server, which then selects the audiovisual content automatically on the basis of the set selected; and a step of updating the record file, especially in the event of modification of the audiovisual content selected by the presentation server.

The present invention relates to a method of recording audiovisual contents broadcast according to a schedule. It also relates to a system for recording audiovisual contents broadcast according to a schedule, a presentation server, and an access terminal, adapted to execute such a method.

### FIELD OF THE INVENTION

The term “broadcasting” is used generally to mean broadcasting audiovisual contents on any type of medium, such as satellite, cable, terrestrial radio transmission or the Internet.

To be more precise, the invention relates to a method including:
a step of selecting from an access terminal an audiovisual content to be recorded, the content being associated with a broadcast date and time, and
a step of the access terminal receiving a record file of the selected audiovisual content, said file containing information identifying the audiovisual content and the scheduled date and time for broadcasting it.

### BACKGROUND OF THE INVENTION

Methods of the above kind are known in the art.

For example, it is possible to consult a program guide on a website from an access terminal connected to the Internet. The site generally facilitates searching and in due course, subject to a little browsing and filling in search criteria, shows all available information on audiovisual contents of interest to the user, including information identifying the contents and the scheduled date and time for broadcasting them. This information may then be downloaded into the access terminal.

There is also provision for broadcasting audiovisual contents associated with descriptive data. The DVB (for “Digital Video Broadcasting”) forum has drawn up the DVB-SI (for “Service Information”) standard for broadcasting information on broadcast contents. But most of time the information is very limited (channel identifier, broadcast identifier, broadcast title, start time, end time, parental control, etc.).

Finally, the specifications of the TV Anytime forum propose a solution for automatic recording of audiovisual contents associated with descriptive data appropriate to the content. However, that forum does not propose a simple solution to selecting audiovisual contents on the basis of a topic interesting more particularly a user. The user must in all cases know in advance which contents are liable to be of interest.

### OBJECTS AND SUMMARY OF THE INVENTION

The invention aims to eliminate the above drawbacks by providing a method of recording audiovisual contents broadcast according to a schedule that is capable of processing topic-oriented selections of audiovisual contents and that constitutes a relatively simple solution which does not require an outstanding processing capacity from the access terminal.

To this end, the invention consists in a method of the above-specified type, further comprising:
a preliminary step of the access terminal selecting a set of contents having a common topic, said set being offered by an audiovisual content presentation server, which then executes the selection of the audiovisual content automatically on the basis of the selected set; and
a step of updating the record file, especially in the event of modification of the audiovisual content selected by the presentation server.

A method conforming to the invention may further comprise one or more of the following features:
the updating step is executed if the date and/or the time of broadcasting the selected audiovisual content is modified;
the updating step is executed if the selection of the audiovisual content by the presentation server is modified;
the updating step is executed if the selected audiovisual content is replaced by another audiovisual content or is cancelled;
the record file includes at least one field marked by a marker and defining information identifying the corresponding audiovisual content, associated with data describing said content;
the record file includes at least one field marked by a marker and defining, for a given audiovisual content in the same file, a content identifier, associated with a content already recorded in the storage means of the access terminal;
the syntax of files exchanged between the access terminal and the server is defined by a unique data structure schema, in particular an XML schema;
the presentation server comprises means for identifying a terminal that has selected an audiovisual content and the updating step includes notifying a modification relating to said audiovisual content as soon as the presentation server is notified of said modification;
the record file includes the address of an update server for generating a request to update the record file sent by the terminal to the update server;
the request is an HTTP request;
the terminal sends the request to update the record file periodically up to the date and time scheduled for broadcasting the selected audiovisual content;
the terminal sends the request to update the record file increasingly often as the date and time for recording the selected audiovisual content approaches; and
the record file includes a field marked by a marker and defining the address of the update server.

The invention further consists in a system for recording audiovisual contents broadcast according to a schedule, which system is adapted to execute a method as defined above and comprises a presentation server for presenting said audiovisual contents and an access terminal comprising means for selecting a set of contents offered by the presentation server and having a common topic, the selection of at least one audiovisual content being automatically executed by the presentation server, on the basis of the set that has been selected in order to supply to the access terminal a record file of the selected audiovisual content, said file containing information identifying the audiovisual content and the date and time scheduled for broadcasting it.

The invention further consists in an update server adapted to execute a method as defined above and including means for selecting at least one audiovisual content and for transmitting a record file of the selected audiovisual content, said file containing information identifying the audiovisual content and the date and time scheduled for broadcasting it, on the basis of a set of contents having a common topic selected from the access terminal.

Finally, the invention also provides an access terminal adapted to execute a method as described above.

### BRIEF DESCRIPTION OF THE DRAWINGS

The invention will be better understood after reading the following description, which is given by way of example only and with reference to the appended drawings, in which:

FIG. 1 shows schematically the general structure of a recording system of the invention;

FIG. 2 represents a page presenting audiovisual contents that are broadcast according to a schedule and may be recorded using a first embodiment of the invention;

FIG. 3 shows the successive steps of a first embodiment of a recording method of the invention;

FIG. 4 shows a method of updating an access terminal IP address adapted to execute a second embodiment of the invention; and

FIG. 5 shows the successive steps of a recording method, using a second embodiment of the invention.

### MORE DETAILED DESCRIPTION

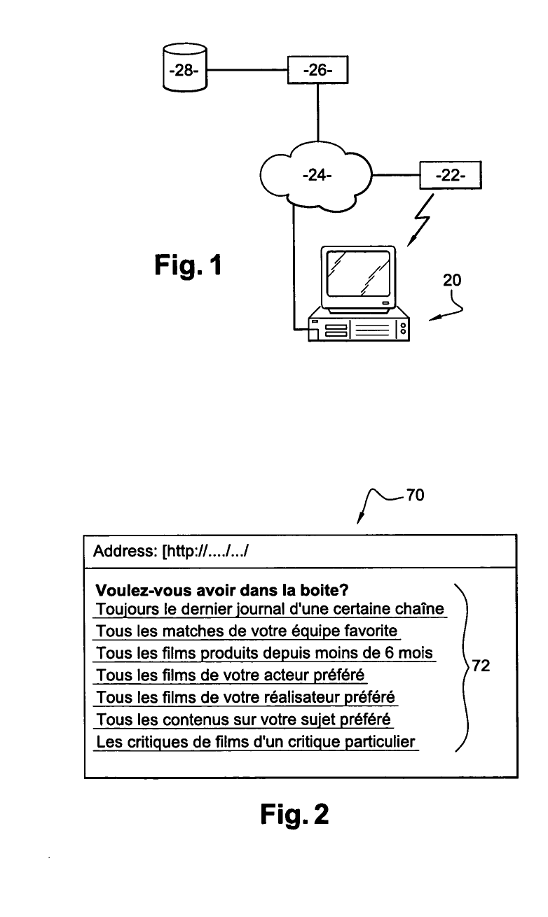

The system shown in FIG. 1 includes a terminal 20 that is used to access audiovisual contents broadcast by a program broadcaster 22.

The access terminal 20 and the broadcaster 22 are moreover connected to an information transmission network, such as the Internet network 24, for example, enabling them to exchange information with an audiovisual content presentation server 26. The terminal 20 incorporates means for storing audiovisual contents, in particular broadcast contents.

The presentation server 26 offers users of the Internet 24 pages presenting audiovisual contents to be broadcast by the broadcaster 22. Information describing the audiovisual contents is held in a database 28 which is connected to the presentation server 26 and is regularly updated by the broadcaster 22 via the presentation server 26, for example if audiovisual contents are removed from the schedule or a scheduled date and time are modified.

The presentation page 70 shown in FIG. 2 is managed by the server 26 and may be consulted by a user of the access terminal 20 via the Internet 24. This is adapted to execute a first embodiment of the invention.

The presentation page 70 includes a list 72 of record commands, each for recording a set of contents having a common topic. For example, such commands denote “always the latest newscast on a particular channel”, “all matches of your favorite team”, “all films released in the past six months”, “all films with your favorite actor”, “all films of your favorite director”, “all contents on your favorite subject”, “film reviews by a particular critic”.

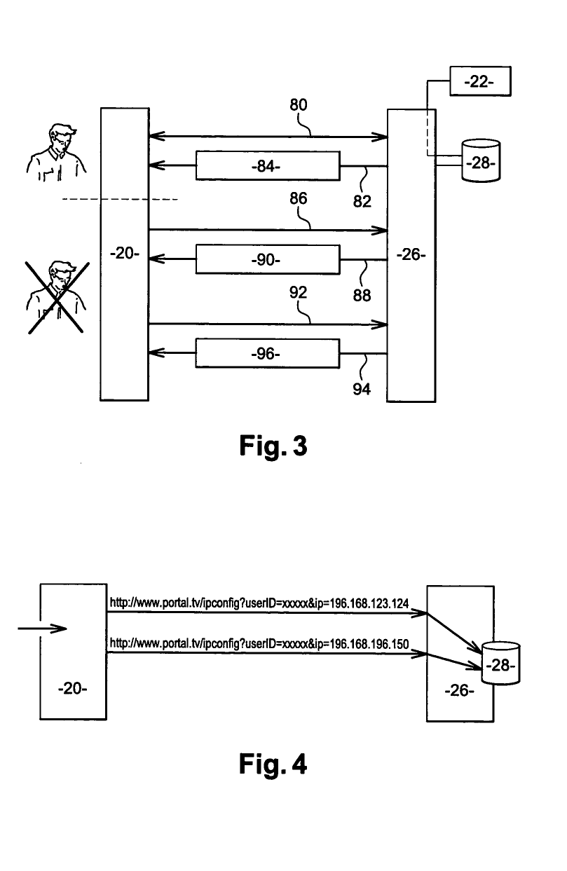

The record request process shown in FIG. 3 includes a first step 80 during which the user interacts with the presentation page 70 and then clicks on one of the record commands from the list 72.

Following this step, the presentation server 26 recovers information associated with audiovisual contents whose topic corresponds to the selected record command. This information is stored in the database 28.

Then, in a step 82, it supplies the information to the access terminal 20 in the form of a record request file 84.

The record request film 84 may have the following structure, employing the XML syntax:

<RecordRequest>

<RecordRequestServerAddress?
   http:\\www.TVPortal.com\adrf3j2.REC
<RecordRequestServerAddress>
<Periodicity>
   04:00:00
</Periodicity>
   </RecordRequest>

The record request file 84 includes a “RecordRequest” start markup (<RecordRequest>) and “RecordRequest” end markup (</RecordRequest>). Between these two markups, it comprises data marked out by start and end markup, as per the XML standard.

Of the above data, the universal address of an update server, marked by a “RecordRequestServerAddress” markup, is supplied by the record request file to enable the access terminal 20 thereafter to send requests to update the record request file. In this example, the address is that of the presentation server 26, which also has the function of updating record request files.

The record request file 84 may optionally further comprise periodicity information marked by a “Periodicity” markup to indicate to the access terminal 20 a period for sending update requests. In this example, the presentation server 26 requests to be contacted every 4 hours.

Then, in a step 86 that is repeated automatically at periods indicated by the “Periodicity” field, the terminal 20 sends a request to the presentation server 26 whose address is listed in the record request file 84. The address includes an indication enabling the presentation server 26 to determine the record command selected by the user.

The request may take either of the following two forms:
http:\\www.TVPortal.com\adrf3j2.REC or
http:\\www.TVPortal.com\adrf3j2.REC?MaxRecNb=2.

As indicated in the above examples, the update request may optionally include a variable “MaxRecNb” that specifies the number of successive audiovisual contents corresponding to the chosen topic which the access terminal 20 must record. In a first case, if this variable is not appended to the request, the record request is a request to record the first audiovisual content corresponding to the selected topic. In the second case, the variable “MaxRecNb” is equal to 2, which means that the record request relates to the recording of two successive audiovisual contents corresponding to the chosen topic.

After the above step, the presentation server 26 recovers the information associated with the audiovisual contents selected in the database 28.

In response, the access terminal 20 receives from the presentation server 26, in a step 88, a record file 90 containing the audiovisual contents corresponding to the topic-oriented record request sent by the user.

The record file 90 may have the following structure, using the XML syntax:

```
<Record>
    <UpdateServerAddress>
        http://www.TVPortal.com\adrf3j2.FRG?
    </UpdateServerAddress>
    <RecordElement>
        <ContentId>
            Content n°1
        </ContentId>
        <TVAMain>
            ...
            <ProgramInformation Table>
              ...
            </ProgramInformation Table>
            <ServiceInformation Table>
              ...
            </ServiceInformation Table>
            <ProgramLocation Table>
                <BroadcastEvent>
                    ...
                    serviceIDRef=“34567”
                    fragmentId=“123”
                    fragmentVersion=“121214”
                    ...
                </BroadcastEvent>
            </ProgramLocation Table>
            ...
        </TVAMain>
    </RecordElement>
    <RecordElement>
        <TVAMain>
            ...
        </TVAMain>
    </RecordElement>
</Record>
```

The record file includes a start of file “Record” markup (<Record>) and an end of file “Record” markup (</Record>). Between these two markups, it includes data marked out by start and end markups, as per the XML format.

Of the above data, the universal address of an update server, marked by a “UpdateServerAddress” markup, is supplied by the record file to enable the access terminal thereafter to send requests for updating in the event of modification of the date and/or time of the broadcast, or cancellation of broadcasting an audiovisual content whose description data is in the record file, or substitution of some other audiovisual content for an audiovisual content in the record file. In this example, the address is that of the presentation server 26, which also has the function of updating record files.

The record file 90 further contains data relating to one or more audiovisual contents selected in the step 80. The data for each audiovisual content is marked by a “RecordElement” markup. In the above example, the record file contains two selected audiovisual contents. It therefore contains two fields marked by the “RecordElement” markup. More generally, it may contain any number thereof.

If the user opts to record this audiovisual content instead of another previously recorded audiovisual content in the storage means of the access terminal 20 and identified by the same content identifier, the data corresponding to a selected audiovisual content may optionally include a content identifier marked by a “ContentId” markup.

Finally, the data corresponding to an audiovisual content includes an XML table marked by a “TVAMain” markup and conforming to the specifications of the TV Anytime forum. This table includes a ProgramInformation sub-table for the description of the content, a ServiceInformation sub-table for the description of the service carrying the content, and a ProgramLocation sub-table for the location (time and place) of the content necessary for recording it.

The ProgramLocation sub-table contains, in a “BroadcastEvent” field, an identifier “ServiceIdRef” of the service carrying the content, an identifier “fragmentId” of the content, and an identifier “fragmentVersion” of the version of the information associated with the content.

The record file 90 may optionally further contain a user reference. If so, the reference is marked by a corresponding markup.

If the step 86 is repeated periodically, during the next step 88, the response sent by the presentation server 26 includes an update file that is similar to the update file 96 and is described later.

For example, if the broadcaster 22 modifies the scheduled date and/or time for audiovisual contents, which leads to modifying the database 28, the repeated sending of requests during the step 86 enables updating of the record file 90. In particular, this allows modification of the audiovisual contents to be recorded should a new audiovisual content be scheduled before the next audiovisual content on the selected topic to be recorded.

Then, in a step 92, the terminal 20 generates a request to update the record file on the basis of the information contained in the file. The request contains the address of the server 26 associated with the identifier “fragmentId” and with the identifier “fragmentVersion”. It takes the following concatenated form:

http://www.TVPortal.com\adrf3j2.FRG?fragmentld=123&f ragmentVersion=121214

Where appropriate, for statistical purposes, the request optionally further contains the reference of the user.

As soon as the request is received, the presentation and update server 26 verifies the information relating to the content corresponding to fragmentId=123 stored in the database 28 and its version identifier.

Then, during a final step 94, the server sends a response to the update request. The response contains an update file 96.

The update file 96 may have the following structure, using the XML syntax:

```
<UPDATE_ANSWER type= TYPE>
    <TVAMain>
        ...
        <ServiceInformation Table>
          ...
        </ServiceInformation Table>
        <ProgramLocation Table>
            <BroadcastEvent>
                ...
                serviceIDRef=“34567”
                fragmentId=“123”
                fragmentVersion=“121215”
                ...
            </BroadcastEvent>
        </ProgramLocation Table>
        ...
    </TVAMain>
</UPDATE_ANSWER>
```

If the version identifier of the data from the database matches the version identifier of the request, the information associated with the audiovisual content to be recorded has not changed. In this case, the update file 96 is identified by the value TYPE=“Unmodified”, indicating that the broadcasting of the corresponding content has not been modified.

If the version identifier of the data from the database has a value higher than the version identifier of the request, the information associated with the audiovisual content has been updated since the record file 90 was transmitted. In this case, the update file 96 is identified by the value TYPE=“New-version”, indicating that the descriptive data for the corresponding content has been modified.

As soon as this file is received, the access terminal replaces the corresponding table “TVAMain” in the record file 90. In particular, if the broadcaster 22 has modified the date and/or the time of recording, this update enables the access terminal to take account of this fact for starting a recording.

If the server 26 has replaced the selected content with some other audiovisual content, the update file 96 is identified by the value TYPE=“New-content”, indicating that the audiovisual content to be recorded has been modified. In this case, as in the above case, the corresponding table “TVAMain” is replaced in the record file 90.

If the server 26 has cancelled the selected content, the update file 96 is identified by the value TYPE=“Cancelled”, indicating that the audiovisual content to be recorded has been cancelled. In this case, recording is cancelled.

Finally, if the server does not find the selected content in the database 28, the update file 96 is identified by the value TYPE=“Unknown”, indicating that the audiovisual content to be recorded has not been found. In this case, recording is cancelled.

Steps 92 and 94 are repeated several times, for example regularly every four hours, up to the time of recording the individual content(s) concerned.

An alternative is to repeat steps 92 and 94 several times, and more and more often as the date and time for recording the selected audiovisual content approaches. This option is suitable for the situation in which only one audiovisual content has been selected, of course.

In the examples given in FIG. 2, if the user selects the recording command corresponding to “always the latest newscast on a particular channel”, the record request file 84 takes the following form:

```
<RecordRequest>
    <RecordRequestServerAddress>
        http:\\www.TVPortal.com\lastNewsOfBBC.REC
    <RecordRequestServerAddress>
    <Periodicity>
        04:00:00
    </Periodicity>
</RecordRequest>
```

This record request file contains the address of the server 26 and specifies as the topic the latest BBC newscast. The period for updating a corresponding record file is four hours. The access terminal 20 then consults the presentation server:

http:\\www.TVPortal.com\lastNewsOfBBC.REC, and the server sends it the following file 90:

```
<Record>
    <UpdateServerAddress>
        http:\\www.TVPortal.com\lastNewsOfBBC.REC
    </UpdateserverAddress>
    <RecordElement.
        <ContentId>
            Content No. 1.
        </ContentId>
        <TVAMain>
            <ProgramDescription>
                <ProgramInformationTable version=“2”>
                    <ProgramInformation>
                        programId=“Crid://www.bbc.co.uk/
                        News19122002”
                        <BasicDescription>
                            <Title>
                                BBC News
                            </Title>
                            <Synopsis>
                                News of the day
                            </Synopsis>
                            <Genre href=“:x:x”>
                                </mpeg7:Name>
                            </Genre>
                        </BasicDescription>
                    </ProgramInformation>
        </ProgramInformationTable>
                <ProgramLocationTable version=“2”>
                    <Schedule>
                        <Event>
                            <Program
crid=“crid://www.bbc.co.uk/News19122002-20H00”/>
                            <EventDescription>
                                <PublishedTime>
                                    2002-12-19T20:00:00-00:00
                                </PublishedTime>
                                <PublishedDuration>
                                    P0Y0M0DT0H45M
                                </PublishedDuration>
                            </EventDescription>
                        </Event>
                        <ServiceId Id=“123”/>
                    </Schedule>
                </ProgramLocationTable>
                <ServiceInformationTable>
                    <ServiceInformation serviceId=“123”>
                        <Name>BBC News</Name>
                        <Owner>BBC</Owner>
                    </ServiceInformation>
                </ServiceInformationTable>
            </ProgramDescription>
        </TVAMain>
    </RecordElement>
</Record>
```

As soon as this record file 90 is received, the access terminal is automatically configured to record the audiovisual content(s) corresponding to the dates and times indicated in the file.

After four hours, the terminal sends the above-mentioned update request whether it has already recorded a newscast or not. If a new version of the record file is sent by the server, it reschedules a recording. Steps 92 and 94 are then repeated again.

If, as is possible for the FIG. 4 examples, the user selects the record command “all matches of your favorite team”, the presentation server sends the following record request file, for example:

```
<RecordRequest>
    <RecordRequestServerAddress>
        http://www.TVPortal.com\AllManchesterFootballMatch.REC
    </RecordRequestServerAddress>
    <Periodicity>
        24:00:00
    </Periodicity>
</RecordRequest>
```

This record request file contains the address of the server 26 and specifies as the topic matches played by Manchester, if that team is the user's favorite team. The updating period for a corresponding record file is twenty-four hours.

This record file may take the following form:

```
<Record>
    <UpdateServerAddress>
        http:\\www.TVPortal.com\AllManchesterFootballMatch.REC
    </UpdateServerAddress>
    <RecordElement>
        <TVAMain>
            <ProgramDescription>
                <ProgramInformationTable version=“2”>
                    <ProgramInformation programId=
                        “crid://www.bbc.co.uk/
ManchesterVsLiverpool 2002-back”>
                        <BasicDescription>
                            <Title>
                                Manchester vs Liverpool
                            England Championship - 2002 - back
                            match
                        </Title>
                        <Synopsis>
                            After the first match between Liverpool
                            & Manchester, where Liverpool win 1-0
                            the Manchester football club should win
                            to make the final
                        </Synopsis>
                        <Genre href=“:x:x”>
                            </mpeg7:Name>Sport/football</
                            mpeg7:Name>
                        </Genre>
                    </BasicDescription>
                </ProgramInformation>
    </ProgramInformationTable>
            <ProgramLocationTable version=“2”>
                <Schedule>
                    <Event>
                            <Program crid=
                                “crid://www.bbc.co.uk/
                                ManchesterVsLiverpool2002-
                                back”/>
                        <EventDescription>
                            <PublishedTime>
                              2002-12-19T21:00:00-00:00
                            </PublishedTime>
                            <PublishedDuration>
                              P0Y0M0DT0H100M
                            </PublishedDuration>
                        </EventDescription>
                    </Event>
    <ServiceId Id=“123”/>
                </Schedule>
            </ProgramLocationTable>
            <ServiceInformationTable>
                <ServiceInformation serviceId=“123”>
                    <Name>BBC Sport</Name>
                    <Owner>BBC</Owner>
                </Service Information>
                </ServiceInformationTable>
            </ProgramDescription>
        </TVAMain>
    </RecordElement>
</Record>
```

As soon as this record file 90 is received, the access terminal is automatically configured to record the audiovisual content(s) corresponding to the dates and times indicated in the file.

After twenty-four hours, whether the terminal has already recorded a match or not, it sends the above-mentioned update request. If the server sends a new version of the record file, it reschedules recording. Steps 92 and 94 are therefore repeated again.

If, as is possible in the case of the FIG. 4 examples, the user selects one of the record commands, “all films released in the past six months”, “all films with your favorite actor”, “all films of your favorite director”, “all contents on your favorite subject”, or “film reviews by a particular critic”, the files returned by the server are similar to those for the two situations referred to above.

There follows a precise example of the XML schema of the record file 90:

```
<?xml version=“1.0” encoding=“UTF-8”?>
<xs:schema xmlns:tva=“http://www.tv-anytime.org/2001/08/
metadata”
xmlns:mpeg7=“urn:mpeg:mpeg7:schema:2001”
xmlns:xs=“http://www.w3.org/2001/XMLSchema”
elementFormDefault=“qualified”
attributeFormDefault=“unqualified”
    <!--<import namespace=“http://www.tv-
anytime.org/2001/08/metadata”
schemaLocation=“./tva_metadata_v11.xsd”/>-->
    <xs:elementname=“Record” type=“RecordType”>
        <xs:annotation>
            <xs:documentation xml:lang=“fr”>
                This element is the root of the file xx.REC
            </xs:documentation>
        </xs:annotation>
    </xs:element>
    <xs:complexType name=“RecordType”>
        <xs:sequence>
            <xs:element name=“UpdateServerAddress” type=
“xs:anyType”>
                <xs:annotation>
                    <xs:documentation xml:lang=“fr”>
                        This markup contains the universal
                        address that the terminal will use to
                        look up any changes that may have
                        taken place for the transmissions
                        scheduled for recording
                    </xs:documentation>
                </xs:annotation>
            </xs:element>
            <xs:sequence maxOccurs=“unbounded”>
                <xs:element name= “RecordElement”>
                    <xs:annotation>
                        <xs documentation xml:lang=“fr”>
                            This element represents a record
                            of the user, it contains a TVAMain
                            node. This TVA node must contain
                            the minimum for making a
                            recording, i.e. a
                            ProgramInformationTable, a
                            ServiceInformationTable, and a
                            ProgramLocationTable
                        </xs:documentation>
                    </xs:annotation>
                    <xs:complexType>
                        <xs:sequence>
                            <xs:element ref=“tva:TVAMain”/>
<xs:element name= “ContentId” minOccurs=“0”>
                                <xs:annotation>
                                    <xs:documentation xml:lang=“fr”>
                                            This element, if present,
                                            indicates to the terminal
                                            that the content must
                                            replace a content already
                                            present on his disc and
                                            having the same identifier
                                        </xs:documentation>
                                </xs:annotation>
                            </xs:element>
                        </xs:sequence>
                    </xs:complexType>
                </xs:element>
            </xs:sequence>
        </xs:sequence>
    </xs:complexType>
</xs:schema>
```

There follows a precise example of the XML schema of the record request file 84:

```
<?xml version=“1.0” encoding=“UTF-8”?>
<xs:schema xmins:xs=http://www.w3-org/2001/XMLSchema”
elementFormDefault=“qualified” attributeFormDefault=“unqualified”>
    <xs:elementname=“RecordRequest” type=“RecordRequestType”>
        <xs:annotation>
            <xs:documentation>Document root element
</xs:documentation>
        </xs:annotation>
    </xs:element>
    <xs:complexType name=“RecordRequestType”>
        <xs:sequence>
            <xs:element name=“RecordRequestServerAddress”
type= “xs:anyURI”>
                <xs:annotation>
                    <xs:documentation>
                        This element contains the universal
                        address to which the terminal must
                        log on to obtain an update of the
                        programming information
                    </xs:documentation>
                </xs:annotation>
            </xs:element>
            <xs:element name=“Periodicity”
type=“xs:duration” minOccurs=“0”>
                <xs:annotation>
                    <xs:documentation>
                        This element contains the period to
                        which the terminal must refer for
                        effecting its updates
                    </xs:documentation>
                </xs:annotation>
            </xs:element>
        </xs:sequence>
    </xs:complexType>
</xs:schema>
```

In the first embodiment described above, the record request file 84 and the record file 90 include the address of the presentation and update server 26. This enables the access terminal 20 to send update requests in a simple manner, for example using the HTTP format.

In a second embodiment of the invention, the sending by the server of the record file 90 and the updating of that file, by means of updates sent by the update file server 26, are effected spontaneously by the server, using notifications, without the access terminal 20 needing to send requests.

To this end, the second embodiment includes a process for updating the IP address of the access terminal.

As depicted in FIG. 4, in a first declaration step 100, the access terminal sends the presentation server 26 an identifier that identifies it uniquely and its IP (for “Internet Protocol”) address.

As soon as it receives this information, the presentation server 26 stores it in a user database, establishing a link between the IP address and the identifier of the access terminal 20.

Thereafter, as soon as the terminal 20 is assigned a new IP address, in a step 102, it advises the presentation server 26 of this, by means of an HTTP request, during a subsequent step 104. The new IP address of the terminal 20 is then substituted for the previous one in the user database 28 of the presentation server.

Alternatively, any other application, known in the art may be used, that is capable of establishing the correlation between the identifier of the access terminal and its IP address. The DNS system may be used, for example (see http://userID.freeserve.co.uk).

The second embodiment of the recording method of the invention may be implemented by the FIG. 1 system once the user has been declared for the first time.

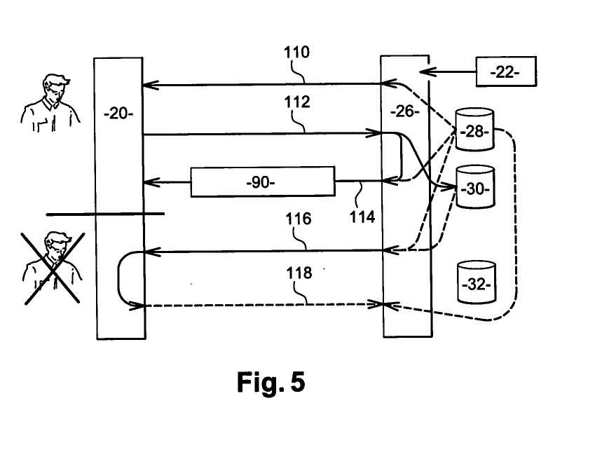

As shown in FIG. 5, in a first step 110 the user interacts with the presentation page 70 and, in the next step 112, clicks on one of the record commands from the list 72.

Selecting one of the record commands from the list 72 causes the access terminal 20 to send a request to the presentation server 26, which extracts the IP address of the terminal from the request. The presentation server looks up the identifier of the terminal that sent the request in the user database 30, which is associated with a database of links between IP addresses and terminal identifiers.

In the next step, it sends a record file 90 to the access terminal. As in the step 88 of the first embodiment, this record file contains the audiovisual contents corresponding to the topic-oriented record request sent by the user. The record file 90 is identical to that of the first embodiment except that in the second embodiment providing the address of the presentation server 26 is optional.

At any time, the server 26 receives from the broadcaster 22 a notification of modification of the date and/or time of broadcasting an audiovisual content, of cancellation of an audiovisual content, or of substitution of one content for another.

As soon as it receives this notification, the presentation server looks up in the user database 30 the access terminals that have received a record file relating to the audiovisual content concerned, for example the terminal 20.

During a subsequent updating step 116, the presentation server sends an HTTP request to the terminal 20 to which the modification relates. In this request, the server 26 may:
Identify the audiovisual content to which the modification relates (by means of the variables fragmented and fragmentVersion);
Send the address of the server to be contacted to update the information;
Provide correction data, if the corrections are simple and do not necessitate contacting the update server.

This is because, if the modification is merely a change to the time of broadcasting the audiovisual content concerned, the time shift can be included in the update request as a parameter. It may be expressed in seconds or minutes, for example, depending on the situation.

If the modification is more serious (for example if the broadcast channel has also changed), the server may decide to include as a parameter an update universal address that the terminal will have to consult during an optional step 118.

1. A method of recording audiovisual contents broadcast according to a schedule, the method including:
a step of selecting from an access terminal an audiovisual content to be recorded, the content being associated with a broadcast date and time, and
a step of the access terminal receiving a record file of the selected audiovisual content, said file containing information identifying the audiovisual content and the scheduled date and time for broadcasting it, and the method further comprising:
a preliminary step of the access terminal selecting a set of contents having a common topic, said set being offered by an audiovisual content presentation server, which then executes the selection of the audiovisual content automatically on the basis of the selected set; and
a step of updating the record file, especially in the event of modification of the audiovisual content selected by the presentation server.

2. A method according to claim 1 of recording audiovisual contents broadcast according to a schedule, wherein the updating step is executed if the date and/or the time of broadcasting the selected audiovisual content is modified.

3. A method according to claim 1 of recording audiovisual contents broadcast according to a schedule, wherein the updating step is executed if the selection of the audiovisual content selected by the presentation server is modified.

4. A method according to claim 1 of recording audiovisual contents broadcast according to a schedule, wherein the updating step is executed if the selected audiovisual content is replaced by another audiovisual content or is cancelled.

5. A method according to claim 1 of recording audiovisual contents broadcast according to a schedule, wherein the record file includes at least one field marked by a markup and defining information identifying the corresponding audiovisual content, associated with data describing said content.

6. A method according to claim 1 of recording audiovisual contents broadcast according to a schedule, wherein the record file includes at least one field marked by a markup and defining, for a given audiovisual content in the same file, a content identifier associated with a content already recorded in the storage means of the access terminal.

7. A method according to claim 1 of recording audiovisual contents broadcast according to a schedule, wherein the syntax of files exchanged between the access terminal and the server is defined by an unique data structure schema, in particular an XML schema.

8. A method according to claim 1 of recording audiovisual contents broadcast according to a schedule, wherein the presentation server comprises means for identifying a terminal that has selected an audiovisual content and the updating step includes notifying a modification relating to said audiovisual content as soon as the presentation server is notified of said modification.

9. A method according to claim 1 of recording audiovisual contents broadcast according to a schedule, wherein the record file includes the address of an update server for generating a request to update the record file sent by the terminal to the update server.

10. A method according to claim 9 of recording audiovisual contents broadcast according to a schedule, wherein the request is an HTTP request.

11. A method according to claim 9 of recording audiovisual contents broadcast according to a schedule, wherein the terminal sends the request to update the record file periodically up to the date and time scheduled for broadcasting the selected audiovisual content.

12. A method according to claim 9 of recording audiovisual contents broadcast according to a schedule, wherein the terminal sends the request to update the record file increasingly often as the date and time for recording the selected audiovisual content approaches.

13. A method according to claim 9 of recording audiovisual contents broadcast according to a schedule, wherein the record file includes a field marked by a markup and defining the address of the update server.

14. A system for recording audiovisual contents broadcast according to a schedule, adapted to execute a method according to claim 1, wherein the system comprises a presentation server for presenting said audiovisual contents and an access terminal comprising means for selecting a set of contents offered by the presentation server and having a common topic, the selection of at least one audiovisual content being then automatically executed by the presentation server, on the basis of the set that has been selected in order to supply to the access terminal a record file of the selected audiovisual content, said file containing information identifying the audiovisual content and the date and time scheduled for broadcasting it.

15. An update server adapted to execute a method according to claim 1, wherein the server includes means for selecting at least one audiovisual content and for transmitting a record file of the selected audiovisual content, said file containing information identifying the audiovisual content and the date and time scheduled for broadcasting it, on the basis of a set of contents having a common topic selected from the access terminal, and means for updating the record file, in particular if the selected audiovisual content is modified.

16. An access terminal adapted to execute a method according to claim 1, comprising means for receiving a record file of a selected audiovisual content, said file containing information identifying the audiovisual content and the date and time scheduled for broadcasting it, which access terminal further comprises means for selecting beforehand a set of contents offered by an audiovisual content presentation server and having a common topic, the selection of the audiovisual content being then automatically executed by the presentation server, on the basis of the set selected, and means for receiving update data for the record file, in particular if the selected audiovisual content is modified.
